(19) United States
(12) Patent Application Publication
(10) Pub. No.: US 2010/0007905 A1
(43) Pub. Date: Jan. 14, 2010

(54) PRINTER SELECTION APPARATUS, AND COMPUTER READABLE RECORDING MEDIUM STORED WITH PRINTER SELECTION PROGRAM

(76) Inventor: Junya MURASHITA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/498,398

(22) Filed: Jul. 7, 2009

(30) Foreign Application Priority Data
Jul. 8, 2008 (JP) 2008-178080

(51) Int. Cl. G06F 3/12

(52) U.S. Cl. 358/1.13; 358/1.15

(57) ABSTRACT

The PC that functions as a printer selection apparatus (1) displays on the display part at least a portion of the printer information stored on the equipment information storage area that stores information concerning the printers on the network, for example, the printer information concerning the printers for which printings based on instructions from the PC were executed previously, and (2) acquires the printer information via the network when displaying the particular printer information. Upon receiving the designation of the filtering condition for narrowing down a plurality of printers into a short list, the PC displays the printer information concerning the printers that fit the designated filtering condition based on the printer information on which the information acquired via the network is reflected.

### CROSS-REFERENCE TO RELATED APPLICATION

This application is based on Japanese Patent Application No. 2008-178080, filed on Jul. 8, 2008, the contents of which are incorporated herein by reference.

### BACKGROUND

1. Technical Field

The present invention relates to a printer selection apparatus and a computer readable recording medium stored with the printer selection program, for selecting a desired printing apparatus from a plurality of printing apparatuses on a network.

2. Description of Related Art

A user can specify various setting items of a printing condition such as paper size and printing color using a control program called a printer driver on a PC (personal computer) and transmit a print job on which such a printing condition is specified to a printer.

A printer driver was proposed recently which is applicable to a plurality of printer models and allows the user to select an output printer arbitrarily each time when printing is executed.

Refer to HP Universal Print Driver, available on the World Wide Web at

“h20000.www2.hp.com/bizsupport/TechSupport/ProductList.jsp?locale=en_US&taskId=135&prodTypeId=18972&prodSeriesId=503548”.

According to this printer driver, it is possible to manage a plurality of printers by classifying them into various groups and to display the usage history of each printer at the printer server.

However, the abovementioned printer driver could not efficiently display a plurality of candidates of the desired printing apparatus and was slow in finding an appropriate printer for the print job desired by the user from the plurality of printers.

Moreover, the abovementioned printer driver can display printer attribute information of only one printer at a time and it needs to initiate a new window in order to display a printer included in a certain group, so that it has been difficult to compare attribute information of a plurality of printers.

### SUMMARY

It is an object of the present invention to provide a printer selection apparatus and a computer readable recording medium stored with the printer selection program, all of which are improved to solve at least one of the abovementioned problems.

It is another object of the present invention to provide a printer selection apparatus and a computer readable recording medium stored with the printer selection program all of which make it easier to select a desired printing apparatus from a plurality of candidates.

To achieve at least one of the abovementioned objects, there is provided a printer selection apparatus, on which installed is a printer selection program for selecting a desired printing apparatus from a plurality of printing apparatuses on a network, which reflects one aspect of the present invention. The printer selection apparatus comprises: an equipment information storage part for storing information concerning printing apparatuses on said network; a display part for displaying, when said printer selection program is initiated, at least a portion of information concerning printing apparatuses that was stored in said equipment information storage part prior to said printer selection program's initiation; an equipment information acquisition part for acquiring information concerning printing apparatuses via said network, when said printer selection program is initiated and at least the portion of the information concerning printing apparatuses stored in said equipment information storage part is displayed on said display part; a reflection part for reflecting the information concerning printing apparatuses acquired by said equipment information acquisition part on the information concerning printing apparatuses stored in said equipment information storage part; and a receiving part for receiving a designation of filtering condition for narrowing down said plurality of printing apparatuses into a short list, wherein said display part displays information concerning printing apparatuses that fit with the designated filtering condition based on the information concerning printing apparatuses reflected by said reflecting part, when the designation of the filtering condition is received.

In said printer selection apparatus, it is preferable that said printer selection program is a printer driver, and said printer selection apparatus further comprises a printing designation part for designating printing to the printing apparatus that corresponds to the information selected by a user among the information concerning printing apparatuses displayed on said display part.

In said printer selection apparatus, it is preferable that said display part displays information concerning a printing apparatus that has executed a printing process based on an instruction from said printer selection apparatus among the information concerning printing apparatuses stored in said equipment information storage part, when said printer selection program is initiated.

In said printer selection apparatus, it is preferable that said display part and said receiving part are provided on the same operating screen.

In said printer selection apparatus, it is preferable that said information concerning printing apparatuses contains attribute information of the printing apparatuses, and said display part displays a list of attribute information of all the printing apparatuses that are the targets of display.

In said printer selection apparatus, it is preferable that the item of filtering condition used for the designation of said filtering condition is set up based on the user's operation.

In said printer selection apparatus, it is preferable that said receiving part receives the designation of multiple kinds of filtering condition with different designation method.

In said printer selection apparatus, it is preferable that said equipment information acquisition part acquires the information concerning printing apparatuses from a server that collects and stores the information concerning printing apparatuses on said network in advance.

In said printer selection apparatus, it is preferable that said equipment information acquisition part acquires the information concerning printing apparatuses from the printing apparatuses on said network.

To achieve at least one of the abovementioned objects, there is provided a computer readable medium stored with a printer selection program for controlling a printer selection apparatus for selecting a desired printing apparatus from a plurality of printing apparatuses on a network, which reflects one aspect of the present invention. The printer selection program causes the printer selection apparatus to execute a process which comprises: (a) when said printer selection program is initiated, displaying on a display part at least a portion of information concerning printing apparatuses that was stored prior to said printer selection program's initiation in an equipment information storage part, which is provided for storing information concerning printing apparatuses on said network; (b) acquiring information concerning printing apparatuses via said network, when said printer selection program is initiated and at least the portion of the information concerning printing apparatuses stored in said equipment information storage part is displayed on said display part; (c) reflecting the information concerning printing apparatuses acquired in said step (b) on the information concerning printing apparatuses stored in said equipment information storage part; (d) receiving a designation of filtering condition for narrowing down said plurality of printing apparatuses into a short list on a receiving part; and (e) when the designation of the filtering condition is received, displaying information concerning printing apparatuses that fit with the designated filtering condition on the display part, based on the information concerning printing apparatuses reflected by said reflecting part.

To achieve at least one of the abovementioned objects, there is provided a printer selection apparatus for selecting a desired printing apparatus from a plurality of printing apparatuses on a network, which reflects one aspect of the present invention. The printer section apparatus comprises: an equipment information acquisition part for acquiring information concerning printing apparatuses on said network; a receiving part for receiving a designation of filtering condition for narrowing down said plurality of printing apparatuses into a short list; an equipment filtering execution part for extracting printing apparatuses that fit the designated filtering condition using the acquired information concerning printing apparatuses, when the designation of the filtering condition is received; a display part for displaying information concerning the extracted printing apparatuses, wherein said information concerning printing apparatuses contains attribute information of the printing apparatuses, and said receiving part has a first receiving part for causing a user to select alternatively from a plurality of filtering conditions, and a second receiving part for causing the user to make a combinational selection from a plurality of filtering conditions.

In said printing equipment selection apparatus, it is preferable that said display part displays a list of attribute information of all the printing apparatuses that are the targets of display.

In said printing equipment selection apparatus, it is preferable that the printer selection apparatus further comprises a printing designation part for designating printing to the printing apparatus that corresponds to information selected by the user among the information concerning printing apparatuses displayed on said display part.

In said printing equipment selection apparatus, it is preferable that said display part and said receiving part are provided on the same operating screen.

In said printing equipment selection apparatus, it is preferable that the item of filtering condition used for the designation of said filtering condition is set up based on the user's operation.

In said printing equipment selection apparatus, it is preferable that said equipment information acquisition part acquires the information concerning printing apparatuses stored in a local storage part and the information concerning printing apparatuses from said network.

In said printing equipment selection apparatus, it is preferable that the items of attribute information displayed on said display part as a list are set up based on the user's operation.

In said printing equipment selection apparatus, it is preferable that the order of display of the information concerning printing apparatuses displayed on said display part as a list can be rearranged in the rising or falling order corresponding to the values of said attribute information based on the user's operation.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a printing system according to a first embodiment of the present invention.

FIG. 2 is a block diagram showing the constitution of the PC shown in FIG. 1.

FIG. 3 is a block diagram concerning the printer selection function of the printer driver.

FIG. 4 is a flowchart showing the sequence for the printing instruction process on the PC.

FIG. 5 is a diagram to show a portion of the printer information acquired from an equipment information storage area.

FIG. 6 is an example of the operation screen for selecting a printer according to the first embodiment.

FIG. 7 is a diagram to show a portion of the printer information acquired by searching over a network.

FIG. 8 shows an example of the printer filtering condition.

FIG. 9 is a diagram showing how the designation of the printer filtering condition is received by the receiving part of the operating screen.

FIG. 10 is a diagram showing how the printer information matching the designated filtering condition is displayed on the display part of the operating screen.

FIG. 11 is a block diagram showing the overall constitution of a printing system according to a second embodiment of the present invention.

FIG. 12 is an example of the operation screen for selecting a printer according to the second embodiment.

### DETAILED DESCRIPTION

The embodiment of this invention will be described below with reference to the accompanying drawings.

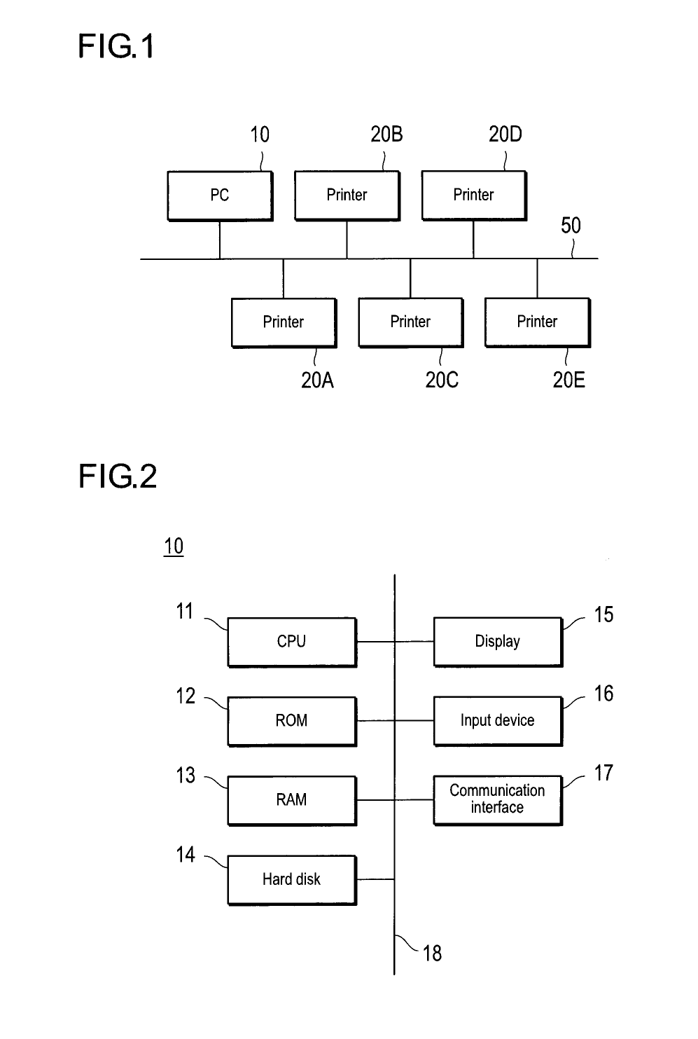

FIG. 1 is a block diagram showing the overall constitution of a printing system according to a first embodiment of the present invention.

The printing system shown in FIG. 1 is equipped with a PC (personal computer) 10 which serves as a printer selection apparatus and printers 20A, 20B, 20C, 20D, and 20E which serve as printing apparatuses. The PC 10 and the printers 20A through 20E are communicably connected with each other via a network 50.

The network 50 consists of various networks such as a LAN connecting computers and network equipment according to standards such as Ethernet, Token Ring, and FDDI, or a WAN that consists of several LANs connected by a dedicated line. The types and the number of equipment to be connected to the network 50 are not limited to those shown in FIG. 1.

FIG. 2 is a block diagram showing the constitution of PC 10 shown in FIG. 1. The PC 10 contains a CPU 11, a ROM 12, a RAM 13, a hard disk 14, a display 15, an input device 16, and a communication interface 17, all of which are interconnected by a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system (OS) and data.

The display 15 is typically a CRT or an LCD and displays various kinds of information. The input device 16 includes a pointing device such as a mouse, a keyboard, and others, and is used for executing various kinds of inputs.

The communication interface 17 is an interface for communications between other equipment, such as printers 20A through 20E, for which various local connection interfaces, e.g., network interfaces such as Ethernet, Token Ring, and FDDI standards, serial interfaces such as USB (Universal Serial Bus) and IEEE 1394, parallel interfaces such as SCSI, IEEE 1284, and wireless communication interfaces such as Bluetooth®, IEEE 802, HomeRF®, IrDA®, as well as telephone circuit interfaces for connection to telephone circuits can be used.

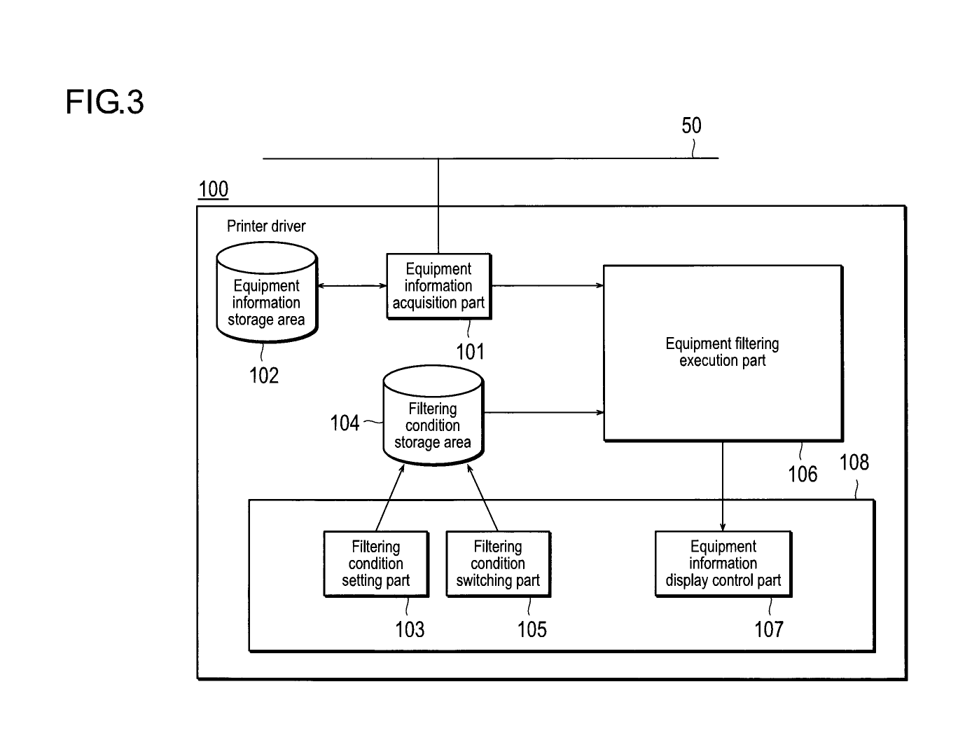

Document file preparation and editing applications as well as a printer driver 100 (see FIG. 3) are installed on the hard disk 14.

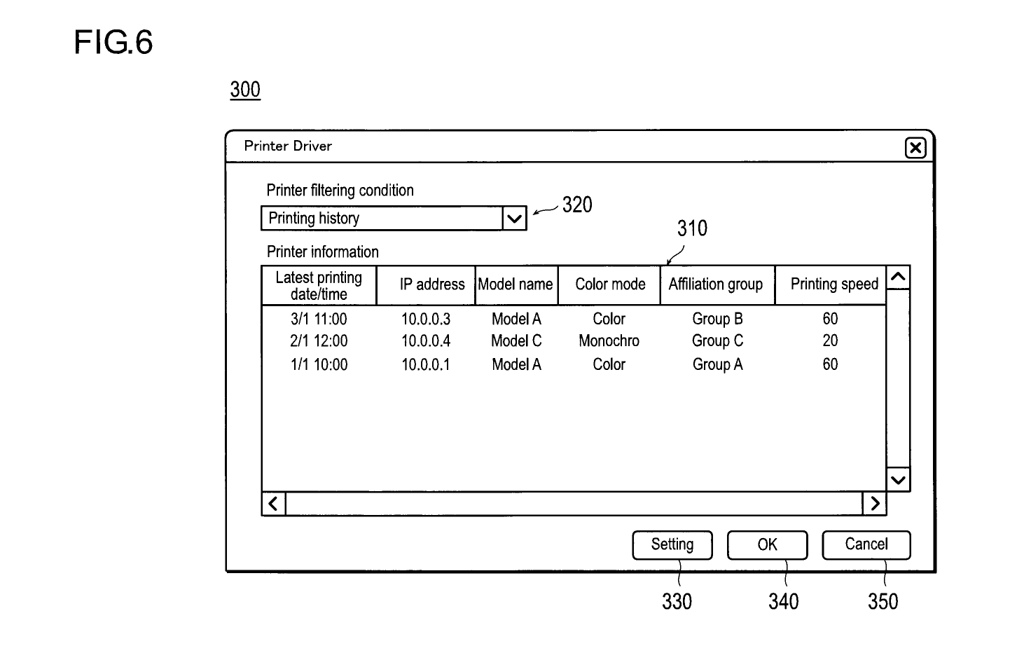

The printer driver 100 is a program for generating print jobs and is installed on the OS stored in the PC 10, the host computer. In the present embodiment, the printer driver 100 can select at the time of printing a printer to which a print job is to be outputted among a plurality of printers 20A through 20E on the network 50 based on the user's operation using an operating screen 300 (see FIG. 6 etc.) to be described later.

FIG. 3 is a block diagram concerning the printer selection function of the printer driver 100. In FIG. 3, functions other than the printer selection function are omitted.

As shown in FIG. 3, the printer driver 100 has an equipment information acquisition part 101, an equipment information storage area 102, a filtering condition setting part 103, a filtering condition storage area 104, a filtering condition switching part 105, an equipment filtering execution part 106, and an equipment information display control part 107 as constitutional elements for realizing the functions for selecting a desired printer from a plurality of printers on the network.

The printer driver 100 is stored in the hard disk 14, read to the RAM 13, and executed by the CPU 11 at the start up time. This enables the abovementioned constitutional elements of the printer driver 100 to function as intended.

The equipment information acquisition part 101 reads and acquires the printer-related information (hereinafter called also “printer information”) stored in the equipment information storage area 102, and also acquires the printer information by means of communications via the network 50. The equipment information area 102 is assigned to RAM 13, which is a local storage area.

The equipment information storage area 102 is an area for storing the printer information which the equipment information acquisition part 101 acquired from an object printer by communicating with it via the network 50. Also, after the printing operation based on the instruction from the PC 10, the information of the final printing date and time, etc. included in the printer information concerning the printer of the output destination are updated.

The filtering condition setting part 103 sets up the filtering condition for narrowing down on the printers with a certain characteristic using the printer information delivered by the equipment information acquisition part 101.

Let us explain here about the operating screen for selecting a printer consulting with FIG. 6.

As shown in FIG. 6, the operating screen 300 has a display part 310 that indicates the printer information and a receiving part 320 for receiving the designation of the filtering condition for narrowing down a plurality of printers into a short list. When a designation for filtering condition is received, the display part 310 displays the printer information that fits the designated filtering condition.

When an OK button 340 is depressed while one of the printer information displayed on the display part 310 is selected, for example, by the user by clicking the mouse, the printer that corresponds to the selected printer information is selected finally as the output destination printer that corresponds to the selected printer information. The selection of the output destination printer can be cancelled by depressing the cancel button 350.

The item of filtering condition used for the designation of the filtering condition can be set up by the user's operation. More specifically, the filtering condition item setting screen (not shown) for setting up the filtering condition item is displayed by depressing a setting button 330 provided on the operating screen 300. The user can set up the item of filtering condition by executing specified operations on the filtering condition item setting screen.

For example, the user can define a condition for selecting only the printers whose “printing speeds” are faster than 40 sheets/minute by the following formula:

“printing speed”>40

and name such a condition as “high speed printing.” By doing so, “High speed printing” is added as user-selectable filtering condition in the receiving part 320 provided at the operating screen 300 for receiving the designation of the filtering condition.

As another example, the user can define a condition for selecting only the printers whose IP addresses that are within 192.168.1.0 through 192.168.1.255 by the following formula:

“IP address”=192.168.1.0/24

and name such a condition as “My Department.” By doing so, “My Department” is added as user-selectable filtering condition in the receiving part 320 provided at the operating screen 300 for receiving the designation of the filtering condition.

Other filtering condition items, such as printers having printing histories, i.e., printers that have histories of executing printing based on instructions from the particular PC 10, printers capable of color printing, printers that belong to a certain group among groups that have been grouped previously by certain classifications, etc., can be set up using the filtering condition item setting screen.

Getting back to FIG. 3, the filtering condition storage area 104 is an area of storing the filtering condition for narrowing down on certain types of printers that are set up by the filtering condition setting part 103.

The filtering condition switching part 105 extracts filtering condition used for narrowing down on certain types of printers among various condition stored in the filtering condition storage area 104 based on an instruction by the user at the receiving part 320, and switches the current condition with the extracted condition.

The equipment filtering execution part 106 extracts printer information that fits with the filtering condition specified by the filtering condition switching part 105 using the printer information received from the equipment information acquisition part 101.

The equipment information display control part 107 controls the display part 310 of the operating screen 300 to display the printer information.

The filtering condition setting part 103, the filtering condition switching part 105, and the equipment information display control part 107 as well as operating screen 300 constitute user interface part 108.

The PC 10 may include components other than those components mentioned above, or may lack some of the components mentioned above.

The printers 20A through 20E receive print jobs generated by the printer driver 100 of the PC 10 via the network 50 and execute printing processes based on the particular print jobs. The printers 20A through 20E are compliant with SNMP/MIB. The printers 20A through 20E transmit various responses based on the inquiries or requests from constituent equipment of the network 50 such as PC 10.

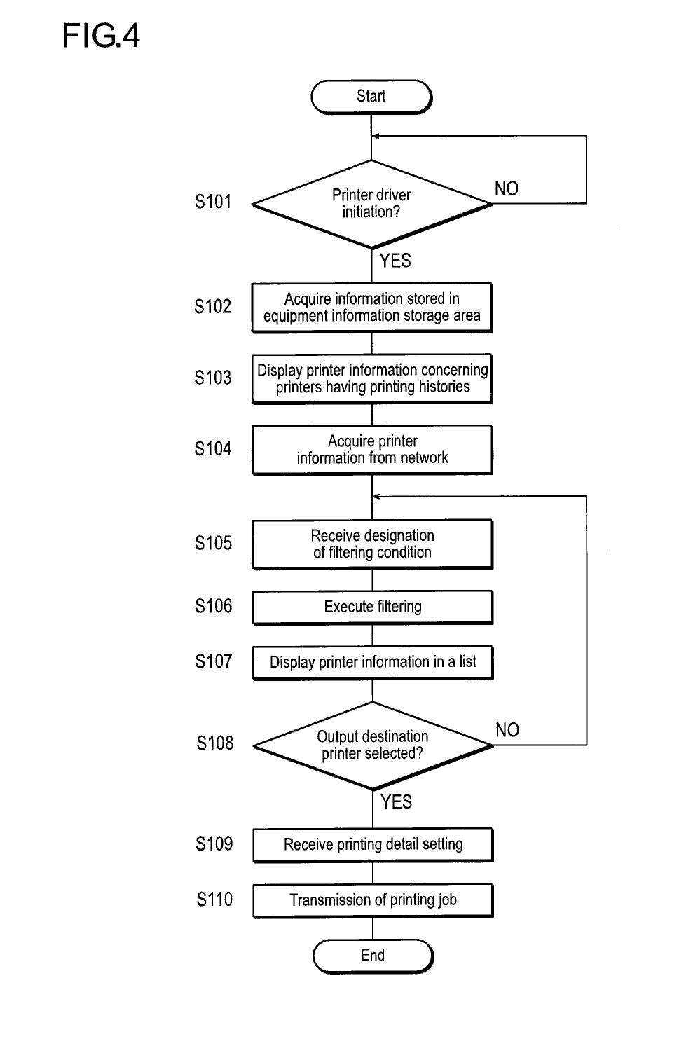

Next, the printing instruction process in the printer 10 will be described below consulting with FIG. 4.

First, the system waits until the printer driver is started up (S101: No).

When the printer driver is initiated (S101: Yes), the printer information which had been stored in the equipment information storage area 102 before the particular printer driver was initiated is acquired (S102).

The printer information which was acquired before via the network 50 is already stored in the equipment information storage area 102. The printer information stored in the equipment information storage area 102 is added or updated every time printer information is searched via the network 50. Each time when a printing process is executed based on an instruction from the PC 10, the information of printing history and last printing date and time is added to the printer information of the printer which executed the particular printing.

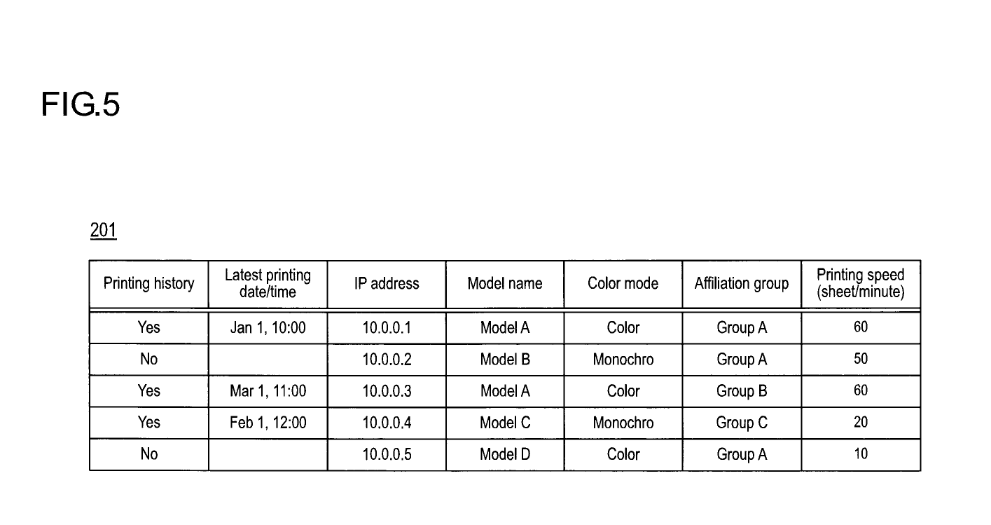

FIG. 5 is a diagram to show a portion of the printer information obtained from an equipment information storage area 102. The printer information 201 shown in FIG. 5 is only a part of the acquired printer information. In addition to what is shown in FIG. 5, the printer information includes attribute information of the printer, and various kinds of attribute information such as printer type name, comment, MAC address, paper size, paper type, status of optional equipment, printer's status, number of printing processes, place of installation, person in charge of, color, shape, printer's external view, etc. The attribute information includes the item of attribute such as “Affiliation group” and the value of attribute such as “Group A.”

Next, the printer information concerning printers having printing histories is displayed (S103). In other words, information of a printer whose “printing process history” is “yes” is displayed on the display part 310 of the operating screen 300 among the printer information 201 (refer to FIG. 5) acquired from the equipment information storage area 102 in steps S102 (refer to FIG. 6). However, the printer information displayed on the display part 310 in step S103 does not necessarily have to be the printer information about the printer with printing process history. In other words, it is constituted in such a way that at least a portion of the printer information already stored in the equipment information storage area 102 is displayed on the display part 310 in step S103.

The display part 310 displays the attribute information of each printer for all of the printers that are the targets of display. The printer information displayed on the display part 310 may include identification information for identifying such as its printer name for identifying it from other printers in addition to the printer's attribute information. The terminology of attribute information is differentiated from the identification information. It is desirable from the viewpoint of the ease of user's comparison and selection works to have a plurality of types of attribute information to be displayed for each printer.

In the default display of the printer information, the printer information is displayed in the order of latest printing date and time. When the column button “Latest printing date and time” of the display part 310 is clicked, it is sorted in the reverse order. Similarly, each time when another column button is clicked, the display order of printer information displayed as a list on the display part 310 is rearranged in a rising order or a descending order according to the value of the attribute information.

When the printer driver is initiated and the printer information is displayed concerning a printer having a printing process history, a process of acquiring the printer information is executed via the network 50 (S104). In other words, a process of acquiring the printer information via the network 50 is initiated regardless of whether there is an instruction for printer search by the user or not under a condition that the printer information concerning printers with the printing process history is being displayed on the display part 310. In the first embodiment, information concerning a plurality of printers is acquired directly from the particular plurality of printers 20A through 20E on the network 50. The printer information thus acquired will be reflected on the printer information already stored in the equipment information storage area 102. In other words, the printer information stored in the equipment is added or updated as needed every time when the printer information is acquired via the network.

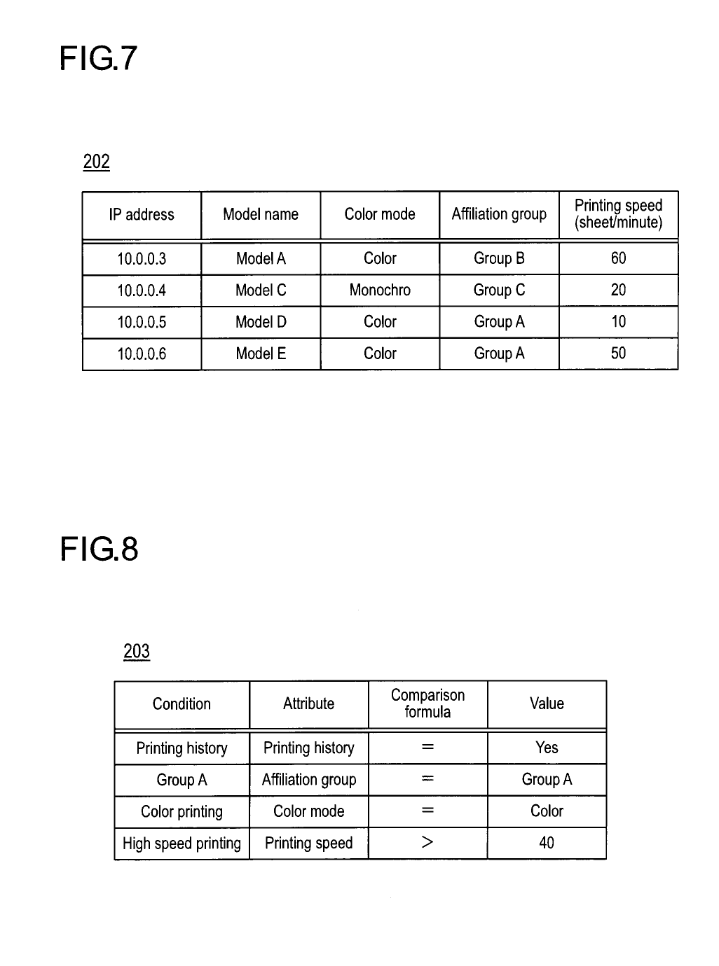

FIG. 7 is a diagram to show a portion of the printer information acquired by searching over a network 50. The printer information 202 shown in FIG. 7 is only a part of the acquired printer information. In addition to what is shown in FIG. 7, the acquitted printer information includes various kinds of attribute information such as printer type name, comment, MAC address, paper size, paper type, status of optional equipment, printer's status, number of printing processes, place of installation, person in charge of, color, shape, printer's external view, etc.

In step S105, designation of filtering condition is received. In other words, the user designates filtering condition on the receiving part 320 on the operating screen 300 in order to extract printers with certain characteristics among the printers that exist on the network 50.

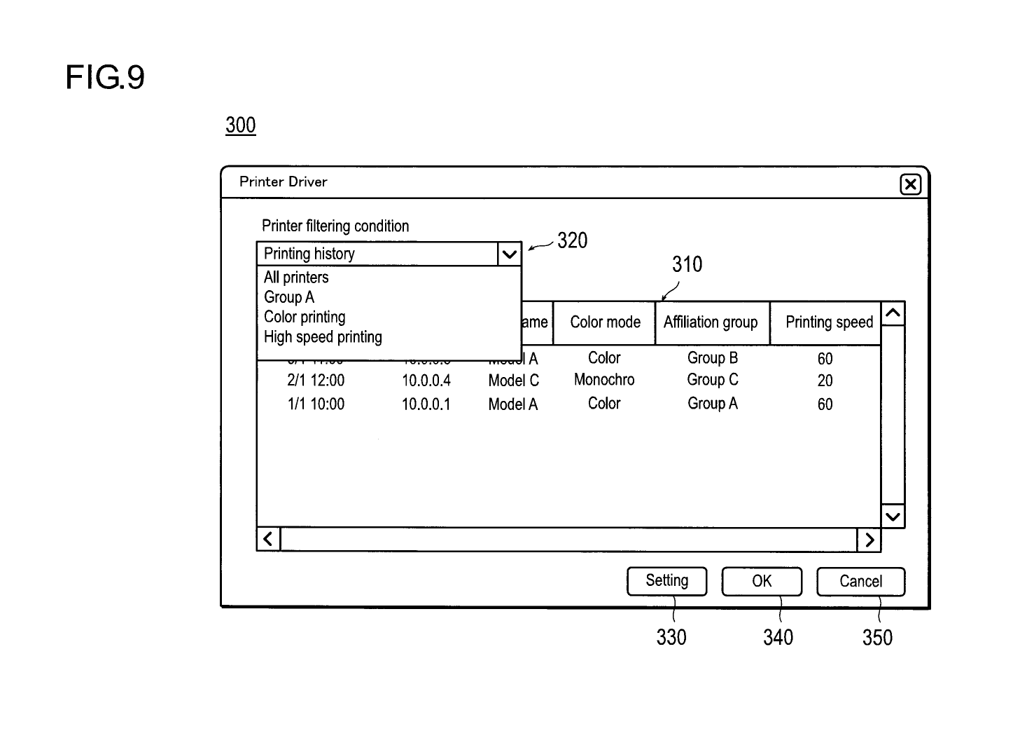

FIG. 8 is an example of printer filtering condition, and FIG. 9 is a diagram that shows how the designation of printer filtering condition is received by the receiving part 320 on the operating screen 300.

A combo-box is used as the receiving part 320, which is the interface of the filtering condition designation. By using the combo-box, one of the preset filtering conditions 203 as shown in FIG. 8 can be designated. In case of FIG. 9, one of the filtering conditions is designated from the selection item list displayed in the combo-box. However, it is also possible to adopt a constitution that displays the text input part and to allow the user to input a new condition directly into the particular text input part. A case of designating “Group A” as filtering condition will be described below.

In step S106, the filtering of printers for short-listing is executed. In other words, based on the printer information of all the printers acquired by the equipment information acquisition part 101, the printers are narrowed down to a short list of only the files that fit to the filtering condition. Since it is assumed here that “Group A” is the short-list filtering condition, printers with the printer information where the attribute “Affiliation group” being “=” to “Group A” in the comparison formula are extracted.

Next, the printer information that fits the designated short-list filtering condition is displayed (S107).

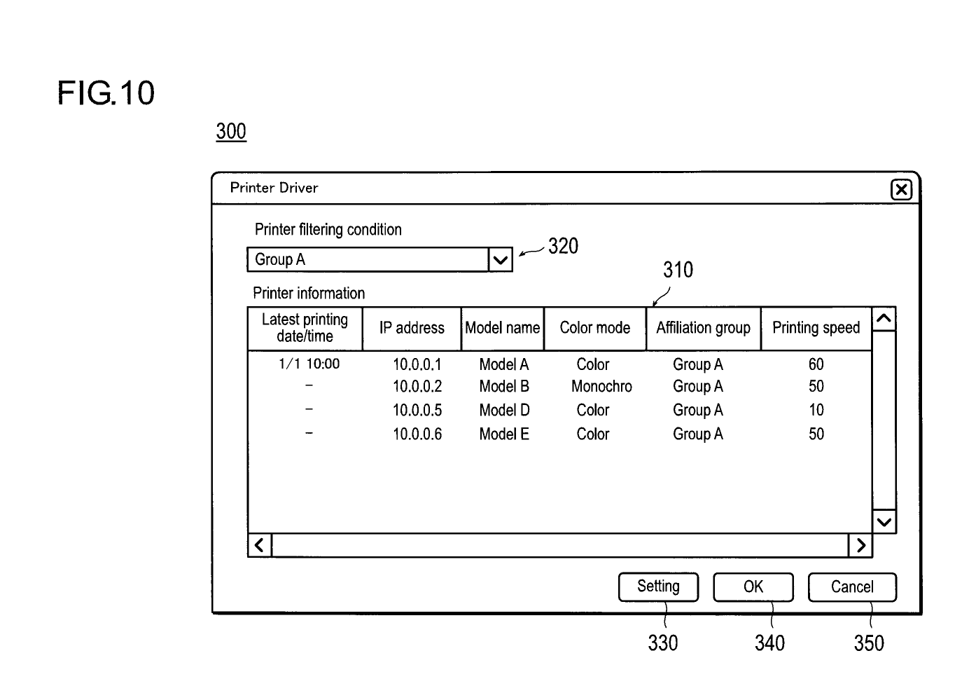

FIG. 10 is a diagram showing how the printer information matching with the designated filtering condition is displayed on the display part 310 of the operating screen 300.

At this point, the printer information concerning all the printers affiliated with “Group A” which are short-listed by the filtering execution part 106 is displayed on the display part 310 provided on the operating screen 300 same as the receiving part 320. In step S107, printers that cannot be used for certain reasons can be omitted from the display on the display part 310.

The attribute information items to be displayed as a list on the display unit 310 can be set up based on the user's operation. Although the attribute information consisting of the date and time of last printing, IP address, model name, color mode, affiliated group, and printing speed is listed in the example shown in FIG. 6, it can also be constituted to display other attribute information.

In step S108, a judgment is made as to whether or not the printer to be the output destination of the print job is selected in the display part 310 which is displaying the short-listed printer information. More specifically, a judgment is made whether or not the OK button 340 is depressed while one of the printer information displayed on the display part 310 is selected by the user.

When it is judged that the output printer is not selected in step S108 (S108: No), the program returns to step S105. On the other hand, if it is judged that the output printer is selected in step S108 (S108: Yes), the program advances to step S109. Thus, the user can change the filtering condition in the receiving part 320 as many times as required until the selection of the output destination printer is completed.

In step S109, the detail setting of the printing condition is performed. The user designates here the setting items of various printing conditions based on the printing functions the selected printer has to have. This detail setting of the printing conditions in the step S109 is identical to the detail setting of the printing conditions in the convention printer driver.

The PC 10 designates printing to the printer selected as the output destination (S110). In other words, the print job is generated and transmitted to the printer selected as the output destination. The printer designated for printing executes printing based on the received print job. The PC 10 then adds to or updates the printing history and latest printing date and time information concerning the output printer stored on the equipment information storage area 102.

As can be seen in the above, in the first embodiment, the PC 10 displays on the display part 310 at least a portion of the printer information stored on the equipment information storage area 102 that stores information concerning the printers on the network 50, for example, the printer information concerning the printers for which printings based on instructions from the PC 10 were executed previously, and acquire the printer information via the network 50 when displaying the particular printer information. In other words, a process of acquiring the printer information via the network 50 is initiated regardless of whether there is an instruction for printer search by the user or not under a condition that the printer information concerning a printer with the printing process history is being displayed on the display part 310. Upon receiving the designation of the filtering condition for narrowing down a plurality of printers into a short list, the PC 10 displays on the display part 50 the printer information concerning the printers that fit the designated filtering condition based on the printer information on which the information acquired via the network 50 is reflected.

Therefore, if the desired printer exists among the printers corresponding to the printer information stored in the equipment information storage area 102, which are displayed on the display part 310, the user can make a selection of the printer information concerning the desired printer quickly from the displayed printer information. Moreover, if the user desires to have a plurality of printers filtered by another filtering condition and have the filtered printers displayed, the process of acquiring the printer information concerning the plurality of printers via the network 50 has already been started, so that the PC 10 can display the printer information concerning the printers that fit the designated filtering condition on the display part 310 at the point when the designation of the filtering condition is received from the user.

In other words, the process of displaying on the display part 310 a plurality of candidates for selecting a desired printer can be done efficiently, and the time required for finding the printer suitable for printing the user desires from the plurality of printers can be shortened.

Also, in the first embodiment, the PC 10 displays the attribute information of all the printers that are the targets of display on the display part 310. Therefore, the user can easily compare the attribute information of the plurality of printers on the display part 310.

Thus, it is easy for the user to select the desired printer from a plurality of the candidates.

Next, the second embodiment of the invention will be described below. In the following paragraphs, only the differences from the abovementioned first embodiment will be described, omitting the descriptions on points that are identical to those in the first embodiment.

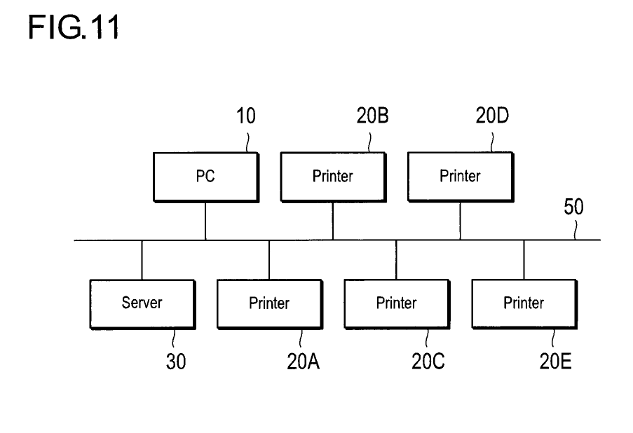

FIG. 11 is a block diagram showing the overall constitution of a printing system according to a second embodiment of the present invention.

The printing system shown in FIG. 11 is equipped with a PC (personal computer) 10 which serves as a printer selection apparatus and printers 20A, 20B, 20C, 20D which serve as a printing apparatuses, and 20E as well as a server 30.

The server 30 communicates with the printers 20A through 20E on the network 50 periodically, acquires, saves and manages the printer information concerning the printers 20A through 20E each time. The server 30 provides the printer information being managed in response to a query or request from constituent equipment on the network 50 such as the PC 10, the host computer, etc.

Next, the printing instruction process in the PC 10 concerning the second embodiment will be described below consulting with FIG. 4.

Since steps S101 through S103 as well as S106 through S110 are identical to those steps of the first embodiment, their descriptions are omitted.

In step S104, a process is conducted for acquiring printer information concerning a plurality of printers via a network 50. In the second embodiment, information concerning a plurality of printers 20A through 20E on the network 50 is acquired from a server 30 that collects in advance and stores the printer information concerning the plurality of printers 20A through 20E.

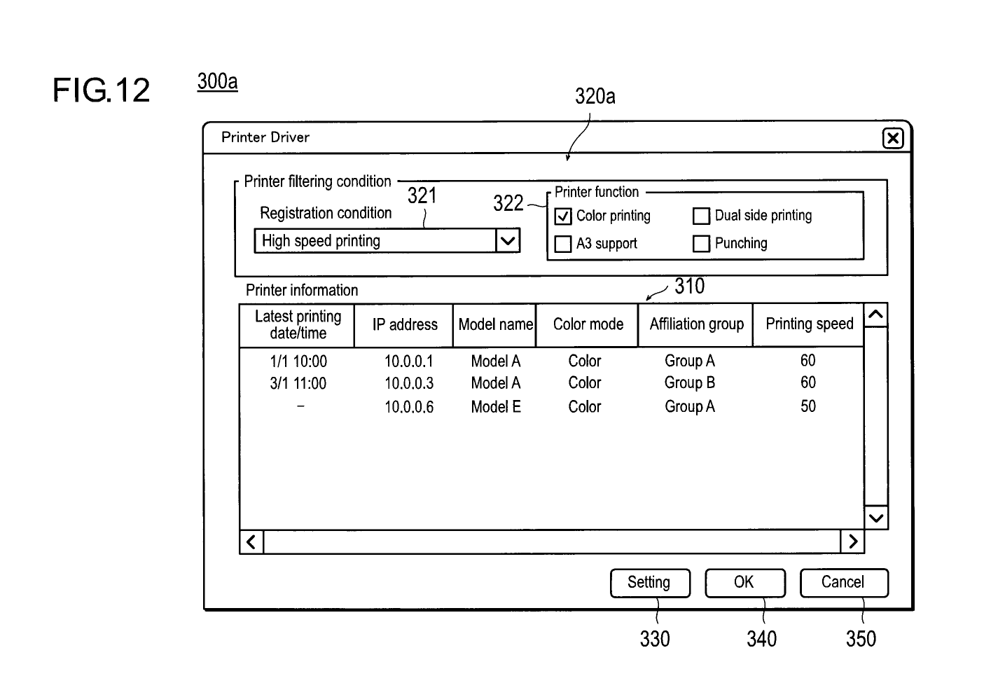

In step S105, designation of filtering condition is received. In other words, the user designates filtering condition on a receiving part 320a on an operating screen 300a (refer to FIG. 12) in order to extract printers with certain characteristics among the printers that exist on the network 50.

FIG. 12 is an example of the operation screen for selecting a printer according to the second embodiment.

As shown in FIG. 12, an operating screen 300a has a display part 310 that indicates the printer information and a receiving part 320a for receiving the designation of the filtering condition for narrowing down a plurality of printers into a short list.

The receiving part 320a according to the second embodiment receives a designation of a several kinds of filtering condition with different designation methods. More specifically, the receiving part 320a, which is the interface for designating filtering condition, is equipped with a combo box receiving part 321 for selectively designating one of the preset filtering condition, and a check box receiving part 322 for designating the attribute information often used as filtering condition.

The item of filtering condition used for designation by means of a check box can be set up by the user's operation similar to the item of filtering condition used for designation by means of the combo box 321. In FIG. 12, “High speed printing” is designated as the filtering condition by means of the combo box receiving part 321, while “Color printing” is designated as the filtering condition by means of the check box receiving part 322. It becomes easier for the user to filter a plurality of printers into a short list by combining the combo box receiving part 321 and the check box receiving part 322.

According to the second embodiment, an action effect similar to that of the first embodiment can be achieved.

It is obvious that this invention is not limited to the particular embodiments shown and described above but may be variously changed and modified without departing from the technical concept of this invention.

For example, although the program for selecting the desired printer from a plurality of printers on a network is constituted as a printer driver in the abovementioned embodiment, the present invention is not limited to it and it can be offered as a separate application program independent of the printer driver.

Also, although a printer is used as a printing apparatus in the abovementioned embodiment, a copying machine, an MFP (Multi-Function Peripheral) and other various kinds of printing apparatuses can be used.

Although a PC is uses as the printer selection apparatus in the abovementioned embodiment, other types of printer selection apparatus, such as a workstation, a server computer, and a mobile telephone can be used as well.

The means and method of conducting various processes in the printer selection apparatus according to the present embodiments can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is ordinarily transferred to and stored in a memory unit such as a hard disk. Said program can also be provided as independent application software or can be built into the software of the printer selection apparatus as a part of its function.

What is claimed is:

1. A printer selection apparatus, on which installed is a printer selection program for selecting a desired printing apparatus from a plurality of printing apparatuses on a network, comprising:
an equipment information storage part for storing information concerning printing apparatuses on said network;
a display part for displaying, when said printer selection program is initiated, at least a portion of information concerning printing apparatuses that was stored in said equipment information storage part prior to said printer selection program's initiation;
an equipment information acquisition part for acquiring information concerning printing apparatuses via said network, when said printer selection program is initiated and at least the portion of the information concerning printing apparatuses that was stored in said equipment information storage part is displayed on said display part;
a reflection part for reflecting the information concerning printing apparatuses acquired by said equipment information acquisition part on the information concerning printing apparatuses stored in said equipment information storage part; and
a receiving part for receiving a designation of filtering condition for narrowing down said plurality of printing apparatuses into a short list, wherein
said display part displays information concerning printing apparatuses that fit with the designated filtering condition based on the information concerning printing apparatuses reflected by said reflecting part, when the designation of the filtering condition is received.

2. The printer selection apparatus as claimed in claim 1, wherein
said printer selection program is a printer driver, and
said printer selection apparatus further comprises a printing designation part for designating printing to the printing apparatus that corresponds to the information selected by a user among the information concerning printing apparatuses displayed on said display part.

3. The printer selection apparatus as claimed in claim 1, wherein
said display part displays information concerning a printing apparatus that has executed a printing process based on an instruction from said printer selection apparatus among the information concerning printing apparatuses stored in said equipment information storage part, when said printer selection program is initiated.

4. The printer selection apparatus as claimed in claim 1, wherein
said display part and said receiving part are provided on the same operating screen.

5. The printer selection apparatus as claimed in claim 1, wherein
said information concerning printing apparatuses contains attribute information of the printing apparatuses, and
said display part displays a list of attribute information of all the printing apparatuses that are the targets of display.

6. The printer selection apparatus as claimed in claim 1, wherein
the item of filtering condition used for the designation of said filtering condition is set up based on the user's operation.

7. The printer selection apparatus as claimed in claim 1, wherein
said receiving part receives the designation of multiple kinds of filtering condition with different designation method.

8. The printer selection apparatus as claimed in claim 1, wherein
said equipment information acquisition part acquires the information concerning printing apparatuses from a server that collects and stores the information concerning printing apparatuses on said network in advance.

9. The printer selection apparatus as claimed in claim 1, wherein
said equipment information acquisition part acquires the information concerning printing apparatuses from the printing apparatuses on said network.

10. A computer readable recording medium stored with a printer selection program for controlling a printer selection apparatus for selecting a desired printing apparatus from a plurality of printing apparatuses on a network, said printer selection program causing the printer selection apparatus to execute a process comprising:
(a) when said printer selection program is initiated, displaying on a display part at least a portion of information concerning printing apparatuses that was stored prior to said printer selection program's initiation in an equipment information storage part, which is provided for storing information concerning printing apparatuses on said network;
(b) acquiring information concerning printing apparatuses via said network, when said printer selection program is initiated and at least the portion of the information concerning printing apparatuses stored in said equipment information storage part is displayed on said display part;
(c) reflecting the information concerning printing apparatuses acquired in said step (b) on the information concerning printing apparatuses stored in said equipment information storage part;
(d) receiving a designation of filtering condition for narrowing down said plurality of printing apparatuses into a short list on a receiving part; and
(e) when the designation of the filtering condition is received, displaying information concerning printing apparatuses that fit with the designated filtering condition on the display part, based on the information concerning printing apparatuses reflected by said reflecting part.

11. The computer readable recording medium as claimed in claim 10, wherein
said printer selection program is a printer driver, and
said process further comprises (f) designating printing to the printing apparatus that corresponds to information selected by a user among the information concerning printing apparatuses displayed on said display part.

12. The computer readable recording medium as claimed in claim 10, wherein
in said step (a), there is displayed on the display part information concerning a printing apparatus that has executed a printing process based on an instruction from said printer selection apparatus among the information concerning printing apparatuses stored in said equipment information storage part.

13. The computer readable recording medium as claimed in claim 10, wherein
said display part and said receiving part are provided on the same operating screen.

14. The computer readable recording medium as claimed in claim 10, wherein
said information concerning printing apparatuses contains attribute information of the printing apparatuses, and
in said step (a) and step (e), a list of attribute information of all the printing apparatuses that are the targets of display is displayed on said display part.

15. The computer readable recording medium as claimed in claim 10, wherein
the item of filtering condition used for the designation of said filtering condition is set up based on the user's operation.

16. The computer readable recording medium as claimed in claim 10, wherein
in said step (d), the designation of multiple kinds of filtering condition with different designation method is received.

17. The computer readable recording medium as claimed in claim 10, wherein
in said step (b), the information concerning printing apparatuses is acquired from a server that collects and stores the information concerning printing apparatuses on said network in advance.

18. The computer readable recording medium as claimed in claim 10, wherein
in said step (b), the information concerning printing apparatuses is acquired from the printing apparatuses on said network.

19. A printer selection apparatus for selecting a desired printing apparatus from a plurality of printing apparatuses on a network, comprising:
an equipment information acquisition part for acquiring information concerning printing apparatuses on said network;
a receiving part for receiving a designation of filtering condition for narrowing down said plurality of printing apparatuses into a short list;
an equipment filtering execution part for extracting printing apparatuses that fit the designated filtering condition using the acquired information concerning printing apparatuses, when the designation of the filtering condition is received;
a display part for displaying information concerning the extracted printing apparatuses, wherein
said information concerning printing apparatuses contains attribute information of the printing apparatuses, and
said receiving part has a first receiving part for causing a user to select alternatively from a plurality of filtering conditions, and a second receiving part for causing the user to make a combinational selection from a plurality of filtering conditions.

20. The printer selection apparatus as claimed in claim 19, wherein
said display part displays a list of attribute information of all the printing apparatuses that are the targets of display.

21. The printer selection apparatus as claimed in claim 19 further comprising:
a printing designation part for designating printing to the printing apparatus that corresponds to information selected by the user among the information concerning printing apparatuses displayed on said display part.

22. The printer selection apparatus as claimed in claim 19, wherein
said display part and said receiving part are provided on the same operating screen.

23. The printer selection apparatus as claimed in claim 19, wherein
the item of filtering condition used for the designation of said filtering condition is set up based on the user's operation.

24. The printer selection apparatus as claimed in claim 19, wherein
said equipment information acquisition part acquires the information concerning printing apparatuses stored in a local storage part and the information concerning printing apparatuses from said network.

25. The printer selection apparatus as claimed in claim 19, wherein
the items of attribute information displayed on said display part as a list are set up based on the user's operation.

26. The printer selection apparatus as claimed in claim 19, wherein
the order of display of the information concerning printing apparatuses displayed on said display part as a list can be rearranged in the rising or falling order corresponding to the values of said attribute information based on the user's operation.

27. A computer readable recording medium stored with a printer selection program for controlling a printer selection apparatus for selecting a desired printing apparatus from a plurality of printing apparatuses on a network, said printer selection program causing the printer selection apparatus to execute a process comprising:
(a) acquiring information concerning printing apparatuses on said network;
(b) receiving a designation of filtering condition for narrowing down said plurality of printing apparatuses into a short list on a receiving part;
(c) extracting printing apparatuses that fit the designated filtering condition using the acquired information concerning printing apparatuses, when the designation of the filtering condition is received; and
(d) displaying information concerning the extracted printing apparatuses on a display part, wherein
said information concerning printing apparatuses contains attribute information of the printing apparatuses, and
said receiving part has a first receiving part for causing a user to select alternatively from a plurality of filtering conditions, and a second receiving part for causing the user to make a combinational selection from a plurality of filtering conditions.

28. The computer readable recording medium as claimed in claim 27, wherein
in said step (d), a list of attribute information of all the printing apparatuses that are the targets of display is displayed on the display part.

29. The computer readable recording medium as claimed in claim 28, wherein
said printer selection program is a printer driver, and
said process further comprises (e) designating printing to the printing apparatus that corresponds to information selected by the user among the information concerning printing apparatuses displayed on said display part.

30. The computer readable recording medium as claimed in claim 27, wherein
said display part and said receiving part are provided on the same operating screen.

31. The computer readable recording medium as claimed in claim 27, wherein
the item of filtering condition used for the designation of said filtering condition is set up based on the user's operation.

32. The computer readable recording medium as claimed in claim 27, wherein
in said step (a), the information concerning printing apparatuses stored in a local storage part and the information concerning printing apparatuses from said network are acquired.

33. The computer readable recording medium as claimed in claim 27, wherein
the items of attribute information displayed on said display part as a list are set up based on the user's operation.

34. The computer readable recording medium as claimed in claim 27, wherein
the order of display of the information concerning printing apparatuses displayed on said display part as a list can be rearranged in the rising or falling order corresponding to the values of said attribute information based on the user's operation.
